(19) United States
(12) Patent Application Publication
(10) Pub. No.: US 2019/0205838 A1
(43) Pub. Date: Jul. 4, 2019

(54) SYSTEMS AND METHODS FOR AUTOMATED CANDIDATE RECOMMENDATIONS

(71) Applicant: Facebook, Inc., Menlo Park, CA (US)

(72) Inventors: Miaoqing Fang, Menlo Park, CA (US); Matthew Hans Chan, San Mateo, CA (US)

(21) Appl. No.: 15/862,306

(22) Filed: Jan. 4, 2018

(51) Int. Cl. G06Q 10/10; G06Q 10/06; G06F 15/18

(52) U.S. Cl. CPC G06Q 10/1053; G06Q 10/06395; G06F 15/18; G06Q 10/06398

(57) ABSTRACT

Systems, methods, and non-transitory computer-readable media can generate a relevance score for each candidate of a plurality of candidates based on a relevance model. The relevance score is indicative of a relevance of the candidate in relation to a talent pipeline. A quality score is generated for each candidate of the plurality of candidates based on a quality model. The quality score is indicative of a likelihood of the candidate to receive a job offer if the candidate is interviewed. A candidate score is generated for each candidate of the plurality of candidates based on the relevance score and the quality score.

### FIELD OF THE INVENTION

The present technology relates to the field of machine learning. More particularly, the present technology relates to techniques for providing job candidate recommendations based on machine learning models.

### BACKGROUND

Recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. An organization can receive large volumes of resumes. The sheer number of resumes received by such an organization can create challenges for the recruiter in vetting the resumes to identify job candidates suited to the organization or a particular job position.

### SUMMARY

Various embodiments of the present disclosure can include systems, methods, and non-transitory computer readable media configured to generate a relevance score for each candidate of a plurality of candidates based on a relevance model. The relevance score is indicative of a relevance of the candidate in relation to a talent pipeline. A quality score is generated for each candidate of the plurality of candidates based on a quality model. The quality score is indicative of a likelihood of the candidate to receive a job offer if the candidate is interviewed. A candidate score is generated for each candidate of the plurality of candidates based on the relevance score and the quality score.

In an embodiment, at least a subset of the plurality of candidates are ranked based on candidate score.

In an embodiment, a ranked list of candidates is provided based on the ranking the at least the subset of the plurality of candidates based on candidate score.

In an embodiment, the ranked list excludes one or more candidates of the plurality of candidates that do not satisfy a minimum relevance score threshold.

In an embodiment, the relevance model is a first relevance model of a plurality of relevance models, the talent pipeline is a first talent pipeline of a plurality of talent pipelines; and the first relevance model is associated with the first talent pipeline.

In an embodiment, the first relevance model is trained based on a first set of training data associated with a first plurality of previous candidates.

In an embodiment, the relevance model is trained based on a binary label for each candidate of the first plurality of previous candidates indicative of whether the candidate was claimed by a recruiter associated with the first talent pipeline.

In an embodiment, the quality model is trained based on a second set of training data associated with a second plurality of previous candidates.

In an embodiment, the first plurality of previous candidates are associated with the first talent pipeline, and the second plurality of previous candidates are associated with the plurality of talent pipelines.

In an embodiment, the quality model comprises a first sub-model configured to output a first quality sub-score and a second sub-model configured to output a second quality sub-score. The quality score is generated based on the first quality sub-score and the second quality sub-score. The first sub-model is trained based on a first binary label for each candidate of a first plurality of previous candidates indicative of whether the candidate was invited to participate in a second round of interviews. The second sub-model is trained based on a second binary label for each candidate of a second plurality of previous candidates indicative of whether the candidate was extended a job offer.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a candidate recommendation module, according to an embodiment of the present disclosure.

FIG. 2 illustrates an example relevance module, according to an embodiment of the present disclosure.

FIG. 3 illustrates an example quality module, according to an embodiment of the present disclosure.

FIG. 4 illustrates an example recommendation module, according to an embodiment of the present disclosure.

FIG. 5A illustrates an example block diagram associated with determining a candidate score based on a candidate profile, according to an embodiment of the present disclosure.

FIG. 5B illustrates an example method associated with automatic determination of candidate recommendations, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Candidate Recommendations Based on Machine Learning Models

As mentioned, recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. Certain organizations can receive large volumes of resumes. The sheer number of resumes received by such organizations can create challenges for recruiters in vetting the resumes to identify suitable job candidates for a particular job position.

One common challenge confronted by organizations and their recruiters is effectively conducting computerized searching through vast amounts of candidate data associated with a large pool of candidates to identify candidates that match certain job positions of the organization. This is particularly true for well-known or desirable employers that may receive an enormous number of submissions for a given job opening. One conventional technique attempts to address the challenge through use by recruiters of cumbersome keyword searches employing long strings of boolean logic. The computerized searches can reflect efforts by recruiters to comprehensively search through resumes for desired job candidates that satisfy various employment criteria applied by the recruiter. Another conventional technique can involve attempts to automate the assessment of a resume in relation to a job position. In this regard, one or more computer implemented algorithms can provide some quantitative measure regarding suitability of the resume in relation to the job position. However, the algorithms are often rudimentary and perform inaccurate assessments. In addition, different algorithms may provide results about a resume that reflect significant differences in their respective assessments.

An improved approach rooted in computer technology overcomes the foregoing and other disadvantages associated with conventional approaches specifically arising in the realm of computer technology. Systems, methods, and computer readable media of the present technology include a system of multiple machine learning models to identify highly qualified job candidates for various job classifications of an organization, such as talent pipelines (or job areas). In general, a plurality of candidate profiles corresponding to a plurality of candidates can be received. Each candidate profile can include, for example, candidate information obtained from a candidate resume. One or more machine learning models, i.e., relevance models, can be trained to analyze a candidate's candidate profile and determine a relevance score for the candidate. In certain embodiments, an organization may have a plurality of talent pipelines (or job areas), and a relevance model can be trained for each talent pipeline. A candidate's relevance score, as determined by a relevance model associated with a particular talent pipeline, may be indicative of the applicant's relevance to that talent pipeline. A separate machine learning model, i.e., a quality model, can be trained to analyze a candidate profile and determine a quality score for the candidate. The quality score can be indicative of a likelihood that the candidate will receive a job offer if the candidate is interviewed by one or more interviewers. Training sets of data for the relevance and/or quality models can include labels relating to, for example, progress of a job candidate in his or her job-related interactions with the company. The training sets of data for the machine learning models can include features of structured data from resumes or other sources relating to, for example, information regarding significant educational or professional achievements. A candidate score can be determined for a candidate based on the candidate's relevance score and quality score. A candidate's candidate score can be indicative of a likelihood that the candidate will receive a job offer for a job position within a particular talent pipeline. More details relating to the disclosed technology are provided below.

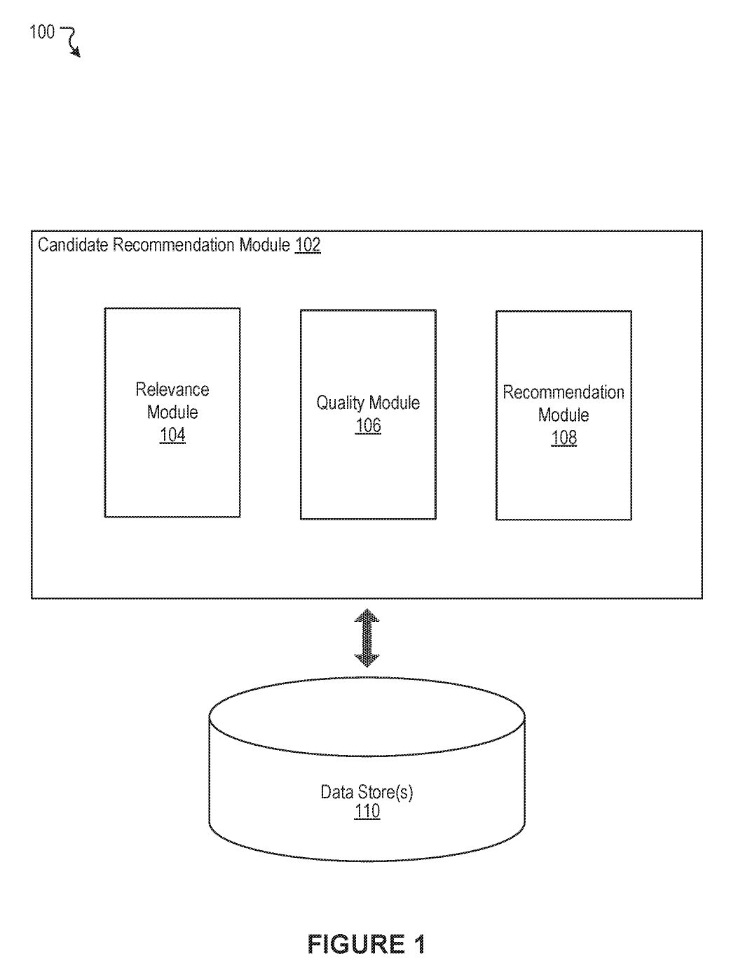

FIG. 1 illustrates an example system 100 including a candidate recommendation module 102, according to an embodiment of the present disclosure. The candidate recommendation module 102 can be configured to receive a set of candidates and identify one or more candidate recommendations from the set of candidates based on various machine learning models. One or more machine learning models discussed in connection with the candidate recommendation module 102 and its components can be implemented separately or in combination, for example, as a single machine learning model, as multiple machine learning models, as one or more staged machine learning models, as one or more combined machine learning models, etc. The candidate recommendation module 102 can be configured to determine a relevance score for each candidate of the set of candidates based on a relevance model. The relevance model may be one of a plurality of relevance models, each relevance model being associated with a particular talent pipeline. The relevance model can be trained to receive a candidate profile and, based on the candidate profile, determine a relevance score that is indicative of the candidate's relevance to a particular talent pipeline or job opening. The candidate recommendation module 102 can also be configured to determine a quality score for one or more candidates of the set of candidates based on a quality model. The quality model can be trained to receive a candidate profile and, based on the candidate profile, determine a quality score that that is indicative of the candidate's likelihood to receive a job offer if the candidate is interviewed. The candidate recommendation module 102 can be configured to determine an overall candidate score for a candidate based on the candidate's relevance and quality scores. Recruiters can be provided computerized search results or electronic notifications about highly qualified job candidates for talent pipelines based on the candidate scores. For example, electronic notifications about highly qualified job candidates identified by the present technology can be provided to recruiters on demand or at regular intervals.

Terms appearing herein are used flexibly. Job classifications, talent pipelines, job roles, job positions, and similar terms, as used herein, can refer to terms that span a spectrum between coarse descriptors to fine grained descriptors associated with or otherwise indicative of a job position, responsibility, role, category, department, etc. An organization can be any entity, such as a company, an establishment, a non-profit, a business, etc. The organization can be of any type or in any industry, such as aerospace and defense, agriculture, automotive, chemicals, construction, consumer goods and services, energy, financial services, firearms, food and beverage, health care, information and technology (e.g., software, hardware, etc.), real estate, manufacturing, mining and drilling, pharmaceuticals and biotechnology, publishing, telecommunications, transportation, etc. While a technology company or related job classifications may be exemplarily discussed in certain contexts for ease of explanation herein, an organization of any industry type or endeavor and related job classifications can be applicable to the present technology. For example, the present technology can be applied to any other type of organization by tailoring the training of machine learning models with features that are relevant to the type of organization and its recruiting strategy.

As shown in the example of FIG. 1, the candidate recommendation module 102 can include a relevance module 104, a quality module 106, and a recommendation module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the candidate recommendation module 102 can be implemented in any suitable combinations.

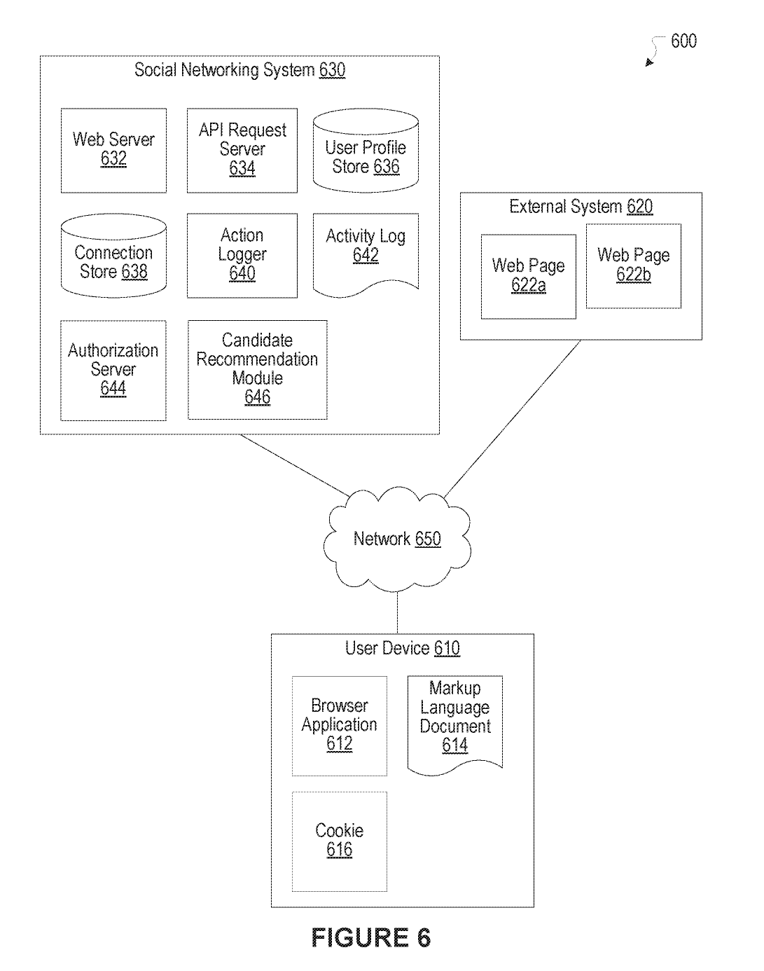

In some embodiments, the candidate recommendation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the candidate recommendation module 102 can be, in part or in whole, implemented as software running on one or more computing devices or systems, such as on a server system or a client computing device. In some instances, the candidate recommendation module 102 can be, in part or in whole, implemented within or configured to operate in conjunction with or be integrated with a social networking system (or service), such as a social networking system 630 of FIG. 6. Likewise, in some instances, the candidate recommendation module 102 can be, in part or in whole, implemented within or configured to operate in conjunction with or be integrated with a client computing device, such as the user device 610 of FIG. 6. For example, the candidate recommendation module 102 can be implemented as or within a dedicated application (e.g., app), a program, or an applet running on a user computing device or client computing system. The application incorporating or implementing instructions for performing functionality of the candidate recommendation module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The candidate recommendation module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the candidate recommendation module 102. For example, the data store 110 can store relevance model training data, one or more relevance models, quality model training data, one or more quality models, candidate profiles, and the like. It is contemplated that there can be many variations or other possibilities.

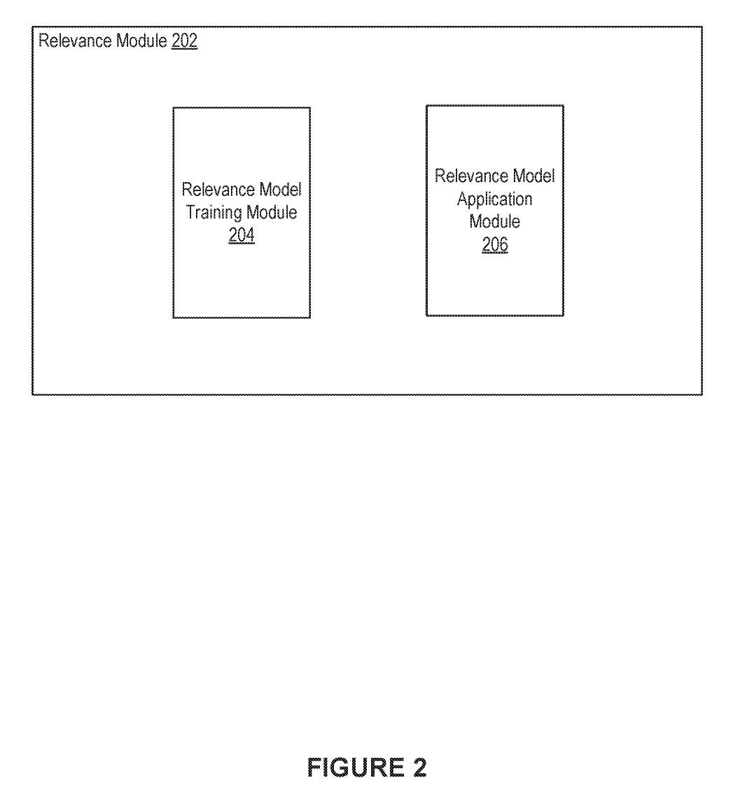

The relevance module 104 can be configured to determine a relevance score for a candidate based on a relevance model. The relevance module 104 can train one or more relevance models. In certain embodiments, a plurality of relevance models can be trained, with each relevance model being associated with a particular talent pipeline. For example, an organization may have the following four talent pipelines: front-end engineer, back-end engineer, marketing, and product design. A separate relevance model can be trained for each talent pipeline, such that a first relevance model is associated with the front-end engineer talent pipeline, a second relevance model is associated with the back-end engineer talent pipeline, a third relevance model is associated with the marketing talent pipeline, and a fourth relevance model is associated with the product design talent pipeline. A relevance model associated with a talent pipeline can be trained to receive a candidate profile for a candidate and, based on the candidate profile, determine a relevance score for the candidate that is indicative of a degree of relevance of the candidate to the talent pipeline. A candidate's relevance to the talent pipeline may, in certain instances, also be indicative of the candidate's likelihood to receive an invitation to interview for a position within the talent pipeline. For example, a first candidate may have credentials and experience to be a very relevant candidate for the front-end engineer talent pipeline, but that same candidate may lack any relevant experience with respect to the marketing talent pipeline. As such, the relevance model associated with the front-end engineer talent pipeline may score the candidate highly (indicating a high relevance to the talent pipeline), whereas the relevance model associated with the marketing talent pipeline may score the candidate poorly (indicating a low relevance to the talent pipeline). Once a relevance model has been trained, the relevance module 104 can receive a candidate profile associated with a candidate and determine a relevance score for the candidate based on the trained relevance model. More details regarding the relevance module 104 will be provided below with reference to FIG. 2.

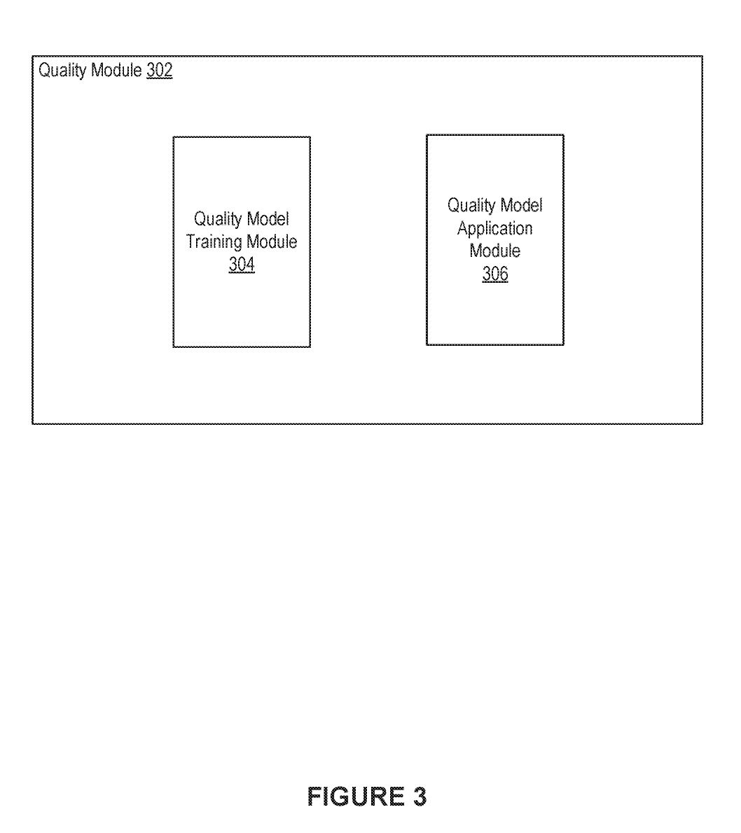

The quality module 106 can be configured to determine a quality score for a candidate based on a quality model. The quality module 106 can train a quality model. The quality model can be trained to receive a candidate profile for a candidate and, based on the candidate profile, determine a quality score for the candidate that is indicative of a likelihood that the candidate will receive an offer of employment (i.e., a job offer) if the candidate is interviewed. As discussed, in certain embodiments, a relevance model may be associated with a particular talent pipeline, such that a relevance score output by a particular relevance model associated with a particular talent pipeline may be indicative of a candidate's relevance with respect to that talent pipeline. In certain embodiments, a quality model may not have an association with any particular talent pipeline, or the quality model may be associated with a plurality of talent pipelines. In such embodiments, a quality score output by the quality model may be indicative of a candidate's likelihood to receive a job offer if the candidate is interviewed for a position with any talent pipeline of a plurality of talent pipelines. This may be the case, for example, if there is insufficient data available to effectively train separate quality models for each talent pipeline. Once a quality model has been trained, the quality module 106 can receive a candidate profile associated with a candidate and determine a quality score for the candidate based on the trained quality model. More details regarding the quality module 106 will be provided below with reference to FIG. 3.

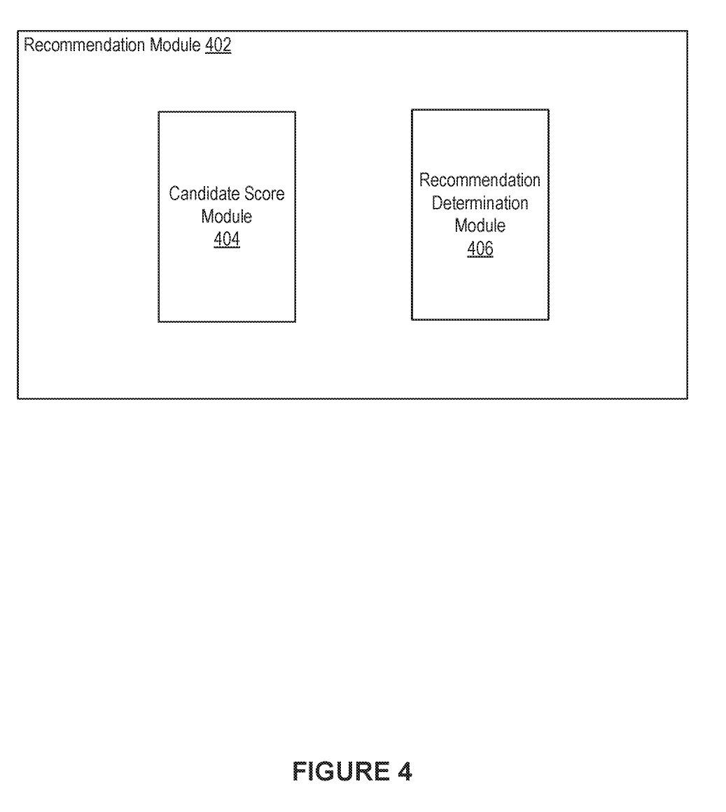

The recommendation module 108 can be configured to identify one or more candidate recommendations from a set of candidates based on recommendation criteria. The recommendation module 108 can be configured to receive relevance scores and quality scores for each candidate of a set of candidates. The recommendation module 108 can determine a candidate score for each candidate based on the candidate's relevance and quality scores. A candidate's candidate score can be indicative of a likelihood that the candidate will receive a job offer if the candidate is considered for a position within a particular talent pipeline. The recommendation module 108 can identify one or more candidate recommendations based on the candidate scores. The recommendation module 108 can provide the one or more candidate recommendations to a recruiter. For example, the recruiter can be provided with a ranked list of candidates ranked based on candidate score. The recruiter can then, for example, contact candidates based on the ranked list. More details regarding the recommendation module 108 will be provided below with reference to FIG. 4.

FIG. 2 illustrates an example relevance module 202 configured to determine a relevance score for a candidate based on a relevance model and a candidate profile associated with the candidate, according to an embodiment of the present disclosure. In some embodiments, the relevance module 104 of FIG. 1 can be implemented as the relevance module 202. As shown in the example of FIG. 2, the relevance module 202 can include a relevance model training module 204 and a relevance model application module 206.

The relevance model training module 204 can be configured to train one or more machine learning models, i.e., one or more relevance models, based on historical candidate information. In certain embodiments, the relevance model can be trained using a gradient boosted decision tree (GBDT) or any other appropriate training methodology. As described above, each relevance model can be associated with a particular talent pipeline (e.g., front-end engineer, back-end engineer, iOS software engineer, Android software engineer, product design, marketing, etc.). Separate relevance models can be trained for different talent pipelines. This may be the case, for example, if there are a sufficient number of positive and negative candidate examples to effectively train a relevance model for each talent pipeline. In certain embodiments, a particular relevance model is associated with a particular talent pipeline (i.e., trained for a particular talent pipeline) based on selection of training data associated with the particular talent pipeline. For example, a set of training data used to train a relevance model associated with a first talent pipeline can include candidate information associated with a first set of previous (or historical) candidates. In one embodiment, the first set of previous candidates can consist of or consistent essentially of a set of candidates that were reviewed and/or considered for a position within the first talent pipeline.

The relevance model training module 204 can train a relevance model based on one or more labels. In some embodiments, the relevance model can be a binary classifier trained on a label. In other embodiments, the relevance model can be a multi-class classifier trained on a plurality of labels. In one instance, a label can relate to progress of a job candidate in recruitment-related interactions with an organization. For example, a label can include whether a candidate is claimed by a recruiter, whether a recruiter performed outreach to a job candidate, whether a job candidate was extended an invitation to interview for a position, whether a job candidate was interviewed, whether a job candidate was provided a first round interview (e.g., a phone screening), whether a job candidate was provided with one or more second round interviews (e.g., one or more onsite interviews), whether a job candidate received an offer of employment, etc. In some embodiments, one label can be used to train the relevance model. In other embodiments, another label or many other labels can be used to train the relevance model.

In one embodiment, a relevance model can be trained based on binary labeling of previous candidates as positive or negative examples. In one example, a candidate that was reviewed and claimed by a recruiter associated with a first talent pipeline can be labeled as a positive example to train a relevance model associated with the first talent pipeline. A recruiter may claim a candidate by, for example, marking the candidate as a candidate to consider for a position within the talent pipeline, contacting the candidate about applying and/or interviewing for a position within the talent pipeline, and the like. Each candidate that was reviewed, but was not claimed by the recruiter can be labeled as a negative example for the first talent pipeline.

Each candidate of a set of previous candidates used to train a relevance model can be associated with a set of candidate information, i.e., a candidate profile. Candidate information in a candidate profile can include information that is obtained from a candidate resume, information obtained from a candidate social networking system profile, information obtained from various job recruitment websites, and the like. Candidate profiles for a plurality of previously candidates, as well as labels indicating whether each candidate is a “positive” example or a “negative” example, can be provided to a machine learning model to train a relevance model. Relevance models can be trained with a training set of data including a candidate corpus of any suitable number (e.g., 2 million, 500, etc.) of candidate profiles as a bag of words.

In some instances, structured data from candidate resumes (or other data sources) can be selected as features for training. The structured data can include any number of candidate characteristics believed to be relevant to the ultimate determination of likelihood to be selected for consideration for a position within a particular talent pipeline. These can include, for example, previous employers, years of experience, previous job titles, schools attended, degrees obtained, areas of concentration (e.g., majors, minors, etc.), skills, and the like. Structured data associated with a set of previous candidates can be used as training data to train a relevance model. In some instances, training features can include neural linguistic embeddings (e.g., word2vec embeddings) which convert terms in a candidate profile or candidate resume into multi-dimensional vector representations in a vector space based on meaning of the terms. In other words, a candidate profile or candidate resume can be converted into a multi-dimensional vector representation based on the terms contained therein. Multi-dimensional vector representations of candidate profiles associated with candidates in a set of previous candidates can be used as a training feature for the relevance model.

In certain embodiments, training features used to train a relevance model can include one or more scores determined by one or more additional machine learning models. In certain instances, each score can also be indicative of a candidate's likelihood to receive consideration for a job position within a particular talent pipeline. By training a relevance model using scores output by various other machine learning models, the relevance model can combine the outputs from the various machine learning models to determine a candidate's relevance score.

One example of a machine learning model from which a score can be used as a training feature for a relevance model relates to a synonymous search technique. Candidate profiles (e.g., candidate resumes) can be identified and scored based on their relevance to one or more search terms associated with searches performed by a recruiter. A machine learning model for a talent pipeline can be trained using terms from a candidate profile corpus. The model can be based on a neural linguistic embedding technique (e.g., word2vec) that converts the terms into vector representations in a vector space based on meaning of the terms. A set of search terms used by one or more of recruiters for a talent pipeline can be represented in the vector space as a set of keywords (or anchor points). In some embodiments, when a recruiter wishes to perform one or more searches on a set of candidate profiles, each candidate profile can be converted into an array of values representing a frequency of unique keywords by determining, for each identified chunk of terms in the candidate profile, a nearest keyword. Each array of values representing a frequency of unique keywords can be normalized to reflect the relative importance of the keywords. An array of values representing a frequency of search terms associated with a search for the talent pipeline can be generated. The array of values associated with a candidate profile and the array of values associated with search terms for the talent pipeline can be combined (e.g., as a dot product) to generate a synonymous search score for each candidate profile regarding relevance to the talent pipeline. Synonymous search scores for a set of previous candidates can be used as one of the features used to train a relevance model.

Another example of a machine learning model from which a score can be used as a training feature for a relevance model relates to a tag space technique. Candidate profile tokens from a candidate profile corpus can constitute a training set of data to train a machine learning model. In addition, tags associated with candidate profiles can be included in the training set of data. In some instances, the tags can be manually selected terms relevant to the candidate profile but not expressly included in the candidate profile text itself. For example, a tag for a candidate profile can be a talent pipeline determined for the candidate profile. The machine learning model can be based on a technique that converts the candidate profile tokens and the tags into vector representations in a vector space based on meaning of the tokens and the tags, such as word2vec. The machine learning model can be used to determine a tag space score that is indicative of a degree to which a candidate profile is relevant to a talent pipeline. In this regard, a candidate profile can be represented as an average vector of the vectors representing the tokens and the tags associated with the candidate profile. A particular talent pipeline can be represented as an average vector of the vectors representing terms associated with the talent pipeline. A distance between the average vector associated with the candidate profile and the average vector associated with the talent pipeline can represent a tag space score regarding the relevance of the candidate profile in relation to the talent pipeline. Tag space scores for a set of previous candidates can be used as one of the features used to train a relevance model.

One or more other machine learning models other than the machine learning model relating to the synonymous search technique and the machine learning model relating to the tag space technique can be used by the relevance model training module 204 to train relevance models. In some embodiments, the relevance model training module 204 is agnostic as to the types of scoring algorithms employed.

The relevance model application module 206 can be configured to receive a candidate profile associated with a candidate, and determine a relevance score for the candidate based on a relevance model. As discussed, a relevance model can be trained using historical candidate information associated with a set of previous candidates. By training the relevance model in this way, the relevance model can determine which candidate features are more predictive of a candidate's relevance to a particular talent pipeline (e.g., are more predictive of a candidate's likelihood to be claimed by a recruiter associated with the particular talent pipeline), and which candidate features are less predicative of a candidate's relevance to a particular talent pipeline. As such, the relevance model application module 206 can receive a candidate profile associated with a candidate, and determine a relevance score for the candidate indicative of the candidate's relevance to a particular talent pipeline based on the trained relevance model. The candidate profile can include at least a subset of the types of information used to train the relevance model. As discussed above, this information can include, for example, previous employers, years of experience, previous job titles, schools attended, degrees obtained, areas of concentration (e.g., majors, minors, etc.), skills, candidate resume text, candidate resume text embeddings, and the like.

FIG. 3 illustrates an example quality module 302 configured to determine a quality score for a candidate based on a quality model and a candidate profile associated with the candidate, according to an embodiment of the present disclosure. In some embodiments, the quality module 106 of FIG. 1 can be implemented as the quality module 302. As shown in the example of FIG. 3, the quality module 302 can include a quality model training module 304 and a quality model application module 306.

The quality model training module 304 can be configured to train one or more machine learning models, i.e., one or more quality models, based on historical candidate information associated with a set of previous candidates. In various embodiments, and as will be described in greater detail herein, a quality model can be associated with a plurality of talent pipelines, and the set of previous candidates can comprise, consist of, and/or consist essentially of previous candidates that were interviewed for a position within any talent pipeline of the plurality of talent pipelines. In other embodiments, a quality model can be associated with a particular talent pipeline, and the set of previous candidates can comprise, consist of, and/or consistent essentially of previous candidates that were interviewed for a position within the particular talent pipeline. In certain embodiments, the quality model can be trained using logistic regression or any other appropriate training methodology.

The quality model training module 304 can train a quality model based on one or more labels. In some embodiments, the quality model can be a binary classifier trained on a label. In other embodiments, the quality model can be a multi-class classifier trained on a plurality of labels. In one instance, a label can relate to progress of a job candidate in recruitment-related interactions with an organization. For example, a label can include whether a candidate is claimed by a recruiter, whether a recruiter performed outreach to a job candidate, whether a job candidate was extended an invitation to interview for a position, whether a job candidate was interviewed, whether a job candidate was provided a first round interview (e.g., a phone screening), whether a job candidate was provided with one or more second round interviews (e.g., one or more onsite interviews), whether a job candidate received an offer of employment, etc. In some embodiments, one label can be used to train the quality model. In other embodiments, another label or many other labels can be used to train the quality model.

In one instance, a quality model can be trained based on binary labeling of candidates as positive or negative examples. The binary label used to train the quality model can differ from a binary label used to train the one or more relevance models. In one instance, the quality model can be trained using positive and negative examples of previous candidates that, having been interviewed for a position, have been extended a job offer for the position. Each candidate that is interviewed and receives a job offer can be labeled as a positive example, while each candidate that is interviewed and does not receive a job offer can be labeled as a negative example.

As described above, it may be possible to train a plurality of relevance models, e.g., one for each talent pipeline of a plurality of talent pipelines. This may be the case, for example, if there are sufficient positive examples in each talent pipeline of previous candidates that have been selected for consideration for that talent pipeline (e.g., claimed by a recruiter associated with that talent pipeline) and if there are also sufficient negative examples in each talent pipeline of previous candidates that were reviewed but were not selected for consideration. However, it may be the case that there are insufficient positive examples of previous candidates that received job offers within each talent pipeline. This can occur because the number of candidates considered for a position in a talent pipeline is typically much larger than the number of candidates that end up receiving job offers. Due to the potentially low number of positive examples to train a quality model, rather than training one quality model for each talent pipeline, a single quality model can be trained using historical candidate information associated with a plurality of talent pipelines (e.g., all talent pipelines within an organization). In such embodiments, a set of training data used to train a quality model associated with a plurality of talent pipelines can include candidate information associated with a set of previous (or historical) candidates, and the set of previous candidates can comprise, consist of, and/or consist essentially of previous candidates that were interviewed for a position within any of the plurality of talent pipelines. In instances where there is sufficient historical data to effectively train separate quality models for each talent pipeline, a separate quality model can be trained for each talent pipeline.

In certain embodiments, a quality model may actually comprise two sub-models. This may be the case, for example, if there are multiple rounds of interviews, such as a first round of interviews (e.g., a phone interview) and a second round of interviews (e.g., one or more onsite interviews). In the example embodiment described above, candidates that were interviewed and then extended job offers were labeled as positive examples for quality model training, and candidates that were interviewed but were not extended a job offer were labeled negative examples. In the two sub-model approach, a first sub-model can be trained to output a first quality sub-score indicative of a likelihood that a candidate, represented by a candidate profile, will be invited to participate in a second round of interviews if the candidate participates in a first round of interviews. A second sub-model can be trained to output a second quality sub-score indicative of a likelihood that a candidate, represented by a candidate profile, will receive a job offer if the candidate participated in a second round of interviews. In this multiple sub-model embodiment, a set of training data for training the first sub-model can comprise, consist of, and/or consist essentially of candidate information associated with a set of candidates that participated in a first round of interviews. Positive examples to train the first sub-model can include candidates that participated in the first round of interviews and were invited to participate in a second round of interviews, while negative examples can include candidates that participated in the first round of interviews but were not invited to participate in a second round of interviews. Similarly, a set of training data for training the second sub-model can comprise, consist of, and/or consist essentially of candidate information associated with a set of candidates that participated in the second round of interviews. Positive examples to train the second sub-model can include candidates that participated in the second round of interviews and then were extended a job offer, while negative examples can include candidates that participated in the second round of interviews but were not extended a job offer. In certain embodiments, a quality score output by a quality model can be determined based on the first quality sub-score determined by the first quality sub-model and the second quality sub-score determined by the second quality sub-model. For example, the quality score may be a product of the first quality sub-score and the second quality sub-score.

Each candidate of a set of previous candidates used to train a quality model can be associated with a set of candidate information, i.e., a candidate profile. Similar to the relevance models discussed above, candidate information used to train a quality model can include information that is obtained from a candidate resume, information obtained from a candidate social networking system profile, information obtained from various job recruitment websites, and the like. Candidate profiles for a plurality of previous candidates, as well as labels indicating whether each candidate of the set of previous candidates is a “positive” example or a “negative” example can be provided to a machine learning model to train a quality model. A quality model can be trained with a training set of data including a candidate corpus of any suitable number (e.g., 2 million, 500, etc.) of candidate profiles as a bag of words.

In some instances, structured data from candidate profiles can be selected as features for training a quality model. The structured data used to train a quality model can include any number of candidate characteristics believed to be relevant to the ultimate determination of likelihood of a candidate to receive a job offer if the candidate is interviewed. These can include, for example, previous employers, years of experience, previous job titles, schools attended, degrees obtained, areas of concentration (e.g., majors, minors, etc.), skills, and the like.

In certain embodiments, features used to train a quality model can also include a plurality of candidate-pipeline combination features. Each candidate-pipeline combination feature can be a combination of a candidate characteristic and a talent pipeline. For example, consider a first candidate that went to School_A for college, obtained a degree in computer science (CS), and worked at Company_A as a software engineer (SWE). Based on this profile, candidate characteristics that can be provided to train the quality model can include School_A, CS, Company_A, SWE. Now, further consider an organization that has three talent pipelines: software, marketing, and design. The quality model training module 304 can generate candidate-pipeline combination features, each of which are a combination of one candidate characteristic and one talent pipeline. In the example scenario above, the candidate-pipeline combination features would include: School_A_software; School_A_marketing; School_A_design; CS_software; CS_marketing; CS_design; Company_A_software; Company_A_marketing; Company_A_design; SWE_software; SWE_marketing; and SWE_design. In addition to candidate characteristics associated with a set of previous candidates, these candidate-pipeline combination features can also be provided as features to train the quality model.

The quality model application module 306 can be configured to receive a candidate profile associated with a candidate, and determine a quality score for the candidate based on a quality model and the candidate profile. As discussed, a quality model can be trained using historical candidate information. By training the quality model in this way, the quality model can determine which features are more predictive of a candidate's likelihood to be extended a job offer if the candidate is interviewed, and which features are less predicative of this likelihood. As such, the quality model application module 306 can receive a candidate profile associated with a candidate, and determine a quality score for the candidate indicative of the candidate's likelihood to receive a job offer if the candidate is interviewed. A candidate profile provided to a trained quality model can include at least a subset of the types of information used to train the quality model. As discussed above, this information can include, for example, previous employers, years of experience, previous job titles, schools attended, degrees obtained, areas of concentration (e.g., majors, minors, etc.), skills, and the like. In certain embodiments, the quality model application module 306 can determine quality scores for each candidate of a set of candidates. In certain embodiments, the quality model application module 306 can determine quality scores only for those candidates of a set of candidates that satisfy a minimum relevance score threshold.

FIG. 4 illustrates an example recommendation module 402 configured to automatically identify one or more candidate recommendations from a set of candidates based on recommendation criteria, according to an embodiment of the present disclosure. In some embodiments, the recommendation module 108 of FIG. 1 can be implemented as the recommendation module 402. As shown in the example of FIG. 4, the recommendation module 402 can include a candidate score module 404 and a recommendation determination module 406.

The candidate score module 404 can be configured to determine a candidate score for at least some candidates of a set of candidates. As described, each candidate in a set of candidates can be assigned a relevance score (based on a relevance model) and a quality score (based on a quality model). A candidate's candidate score can be determined based on a combination of the candidate's relevance score and quality score. For example, in one embodiment, the candidate score can be a product of the relevance score and the quality score. In certain embodiments, a candidate score model (e.g., a machine learning model), such as a logistic regression model, can be trained to determine a candidate score based on the quality score and the relevance score. In certain embodiments a candidate score may be calculated only for those candidates that satisfy a minimum relevance score threshold.

As discussed above, a candidate's relevance score can be indicative of the candidate's likelihood to be claimed by a recruiter associated with a particular talent pipeline for consideration for a position within the particular talent pipeline. As also discussed above, a candidate's quality score can be indicative of a candidate's likelihood to receive a job offer if the candidate is interviewed. This likelihood may be a general likelihood to receive a job offer, and may not be associated with any specific talent pipeline or may be associated with a plurality of talent pipelines. As such, a combination of a candidate's relevance score, which is associated with a particular talent pipeline, and the candidate's quality score, which is not, can provide an indication of a candidate's likelihood to receive a job offer for a particular talent pipeline.

The recommendation determination module 406 can be configured to identify one or more candidate recommendations from a set of candidates based on candidate scores. The recommendation determination module 406 can rank a set of candidates based on candidate score. In certain embodiments, the recommendation determination module 406 can provide the ranked set of candidates to a recruiter (e.g., within a computing device user interface). In certain embodiments, the recommendation determination module 406 can filter the set of candidates based on relevance scores. For example, any candidates that do not satisfy a minimum relevance score threshold can be removed from consideration. As such, the ranked set of candidates can exclude any candidates that do not satisfy the minimum relevance score threshold. In this way, the recruiter is provided with a ranked set of candidates that satisfy a minimum relevance score requirement, and the recruiter can reach out to candidates based on the ranking. In other embodiments, a set of candidates that satisfy a ranking threshold (e.g., the top 10 candidates, the top 100 candidates, the top x candidates) can be identified as candidate recommendations and provided to a recruiter.

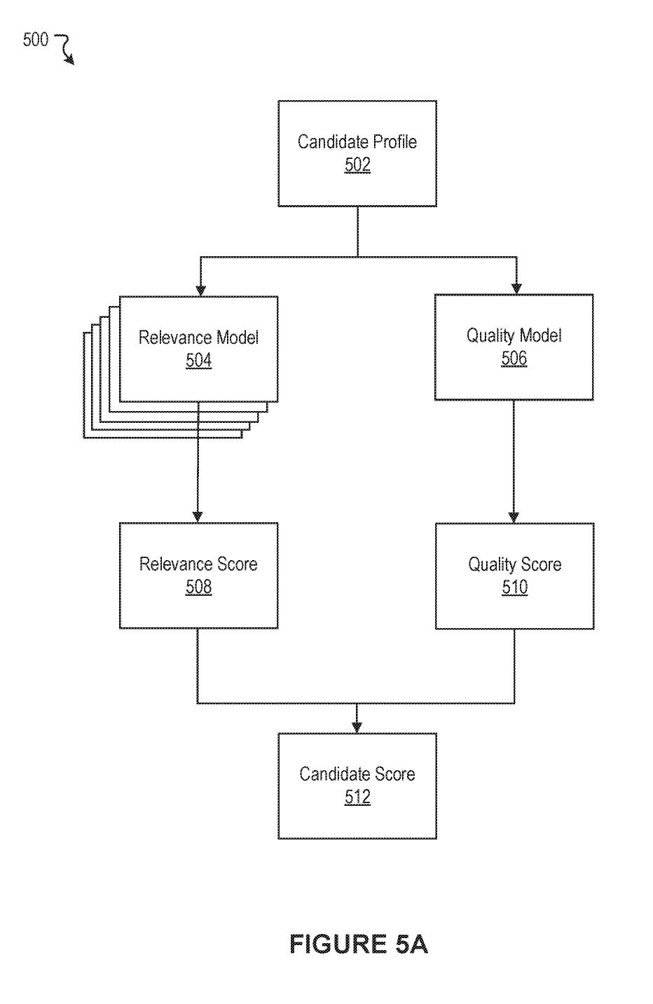

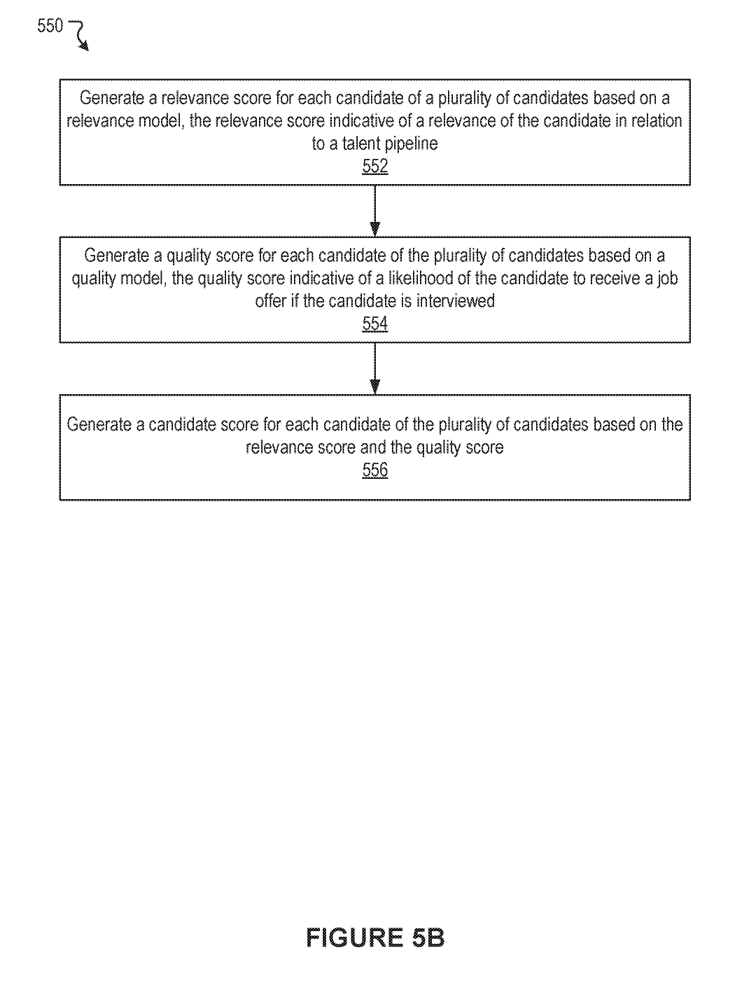

FIG. 5A illustrates an example functional block diagram 500 associated with determining a candidate score based on a candidate profile, according to an embodiment of the present disclosure. The candidate score may be determined, for example, by the candidate recommendation module 102. A candidate profile 502 associated with a candidate can be provided as an input to a relevance model 504 and a quality model 506. The candidate profile 502 can include information from one or a combination of sources, such as a candidate resume, a candidate social networking system profile, a recruitment site, a candidate recruitment site profile, and the like. The relevance model 504 can be one of a plurality of relevance models, and can be associated with a particular talent pipeline of a plurality of talent pipelines. The relevance model 504 can output a relevance score 508 indicative of the candidate's relevance to the particular talent pipeline. For example, the relevance score 508 can be indicative of the candidate's likelihood to be claimed by a recruiter associated with the particular talent pipeline. The quality model 506 can output a quality score 510 indicative of a likelihood that the candidate will receive a job offer if the candidate is interviewed. A candidate score 512 for the candidate can be determined based on the relevance score 508 and the quality score 510. For example, the candidate score 512 can be a product of the relevance score 508 and the quality score 510.

FIG. 5B illustrates an example method 550 associated with providing automated candidate recommendations, according to an embodiment of the present disclosure. It should be appreciated that there can be additional, fewer, or alternative steps performed in similar or alternative orders, or in parallel, within the scope of the various embodiments discussed herein unless otherwise stated.

At block 552, the example method 550 can generate a relevance score for each candidate of a plurality of candidates based on a relevance model, the relevance score indicative of a relevance of the candidate in relation to a talent pipeline. At block 554, the example method 550 can generate a quality score for each candidate of the plurality of candidates based on a quality model, the quality score indicative of a likelihood of the candidate to receive a job offer if the candidate is interviewed. At block 556, the example method 550 can generate a candidate score for each candidate of the plurality of candidates based on the relevance score and the quality score.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a candidate recommendation module 646. The candidate recommendation module 646 can, for example, be implemented as the candidate recommendation module 102, as discussed in more detail herein. As discussed previously, it should be appreciated that there can be many variations or other possibilities. For example, in some embodiments, one or more functionalities of the candidate recommendation module 646 can be implemented in the user device 610.

### Hardware Implementation

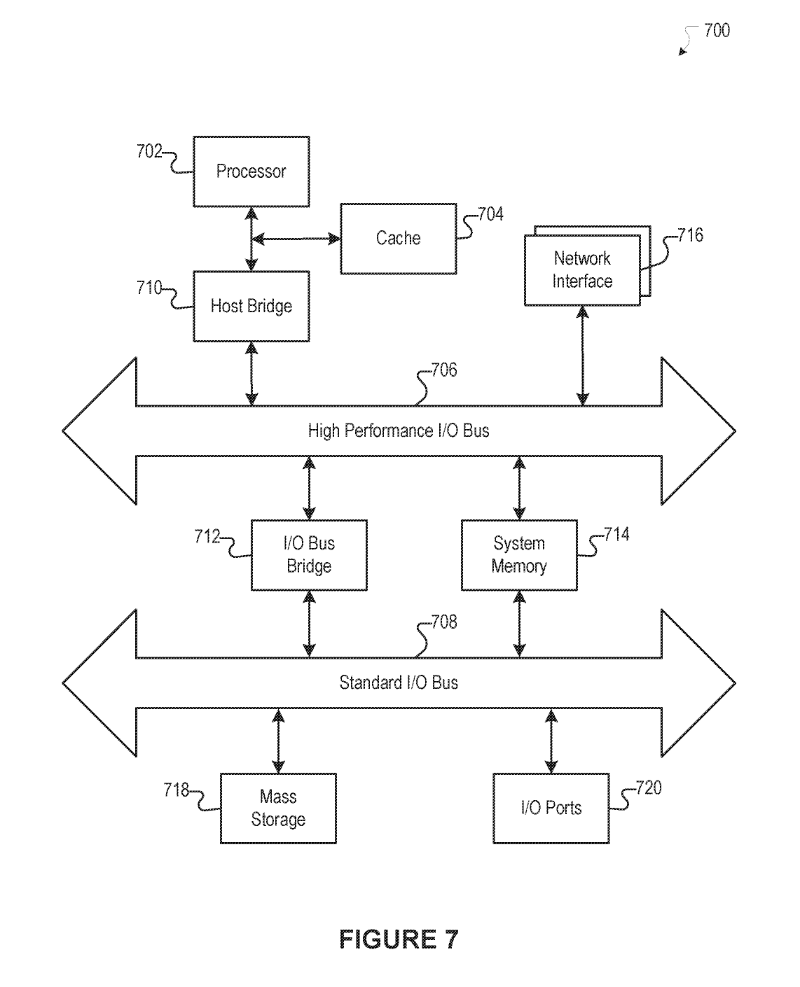

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
generating, by a computing system, a relevance score for each candidate of a plurality of candidates based on a relevance model, the relevance score indicative of a relevance of the candidate in relation to a talent pipeline;
generating, by the computing system, a quality score for each candidate of the plurality of candidates based on a quality model, the quality score indicative of a likelihood of the candidate to receive a job offer if the candidate is interviewed; and
generating, by the computing system, a candidate score for each candidate of the plurality of candidates based on the relevance score and the quality score.

2. The computer-implemented method of claim 1, further comprising ranking at least a subset of the plurality of candidates based on candidate score.

3. The computer-implemented method of claim 2, further comprising providing a ranked list of candidates based on the ranking at least the subset of the plurality of candidates based on candidate score.

4. The computer-implemented method of claim 3, wherein the ranked list excludes one or more candidates of the plurality of candidates that do not satisfy a minimum relevance score threshold.

5. The computer-implemented method of claim 1, wherein
the relevance model is a first relevance model of a plurality of relevance models,
the talent pipeline is a first talent pipeline of a plurality of talent pipelines; and
the first relevance model is associated with the first talent pipeline.

6. The computer-implemented method of claim 5, wherein the first relevance model is trained based on a first set of training data associated with a first plurality of previous candidates.

7. The computer-implemented method of claim 6, wherein the relevance model is trained based on a binary label for each candidate of the first plurality of previous candidates indicative of whether the candidate was claimed by a recruiter associated with the first talent pipeline.

8. The computer-implemented method of claim 7, wherein the quality model is trained based on a second set of training data associated with a second plurality of previous candidates.

9. The computer-implemented method of claim 8, wherein
the first plurality of previous candidates are associated with the first talent pipeline; and
the second plurality of previous candidates are associated with the plurality of talent pipelines.

10. The computer-implemented method of claim 1, wherein
the quality model comprises a first sub-model configured to output a first quality sub-score,
the quality model comprises a second sub-model configured to output a second quality sub-score,
the quality score is generated based on the first quality sub-score and the second quality sub-score,
the first sub-model is trained based on a first binary label for each candidate of a first plurality of previous candidates indicative of whether the candidate was invited to participate in a second round of interviews, and
the second sub-model is trained based on a second binary label for each candidate of a second plurality of previous candidates indicative of whether the candidate was extended a job offer.

11. A system comprising:
at least one processor; and
a memory storing instructions that, when executed by the at least one processor, cause the system to perform a method comprising:
generating a relevance score for each candidate of a plurality of candidates based on a relevance model, the relevance score indicative of a relevance of the candidate in relation to a talent pipeline;
generating a quality score for each candidate of the plurality of candidates based on a quality model, the quality score indicative of a likelihood of the candidate to receive a job offer if the candidate is interviewed; and
generating a candidate score for each candidate of the plurality of candidates based on the relevance score and the quality score.

12. The system of claim 11, wherein the instructions, when executed by the at least one processor, further cause the system to perform: ranking at least a subset of the plurality of candidates based on candidate score.

13. The system of claim 12, wherein the instructions, when executed by the at least one processor, further cause the system to perform: providing a ranked list of candidates based on the ranking at least the subset of the plurality of candidates based on candidate score.

14. The system of claim 13, wherein the ranked list excludes one or more candidates of the plurality of candidates that do not satisfy a minimum relevance score threshold.

15. The system of claim 11, wherein
the relevance model is a first relevance model of a plurality of relevance models,
the talent pipeline is a first talent pipeline of a plurality of talent pipelines; and
the first relevance model is associated with the first talent pipeline.

16. A non-transitory computer-readable storage medium including instructions that, when executed by at least one processor of a computing system, cause the computing system to perform a method comprising:
generating a relevance score for each candidate of a plurality of candidates based on a relevance model, the relevance score indicative of a relevance of the candidate in relation to a talent pipeline;
generating a quality score for each candidate of the plurality of candidates based on a quality model, the quality score indicative of a likelihood of the candidate to receive a job offer if the candidate is interviewed; and
generating a candidate score for each candidate of the plurality of candidates based on the relevance score and the quality score.

17. The non-transitory computer-readable storage medium of claim 16, wherein the instructions, when executed by the at least one processor, further cause the computing system to perform: ranking at least a subset of the plurality of candidates based on candidate score.

18. The non-transitory computer-readable storage medium of claim 17, wherein the instructions, when executed by the at least one processor, further cause the computing system to perform: providing a ranked list of candidates based on the ranking at least the subset of the plurality of candidates based on candidate score.

19. The non-transitory computer-readable storage medium of claim 18, wherein the ranked list excludes one or more candidates of the plurality of candidates that do not satisfy a minimum relevance score threshold.

20. The non-transitory computer-readable storage medium of claim 16, wherein
the relevance model is a first relevance model of a plurality of relevance models,
the talent pipeline is a first talent pipeline of a plurality of talent pipelines; and
the first relevance model is associated with the first talent pipeline.
